(19) United States
(12) Patent Application Publication
(10) Pub. No.: US 2005/0098008 A1
(43) Pub. Date: May 12, 2005

(54) Dispenser for the automated forward feed and cutting of a sheet material, preferably paper or the like

(76) Inventor: Asbjørn Henriksen, (US)

Correspondence Address: HARNESS, DICKEY & PIERCE, P.L.C., P.O. BOX 828, BLOOMFIELD HILLS, MI, 48303, US

(21) Appl. No.: 10/344,123

(22) PCT Filed: Aug. 8, 2001
(86) PCT No.: PCT/NO01/00334

(30) Foreign Application Priority Data
Sep. 9, 2000 (NO) 20004009

(51) Int. Cl. B26D 5/20; B26D 7/00

(52) U.S. Cl. 83/202; 83/949; 83/650; 83/76.6

(57) ABSTRACT

There is described a device for the power-operated forward feed of a sheet material, preferably paper or the like, where one or more rolls of material (4, 5) are arranged in a stand (3) placed on a casing (2) housing power supply (13) and an electric motor (16), wherein actuation of the motor causes the forward feed of the material before it is cut off by means of a cutting device, and where there is provided a printed circuit board (14) containing control circuits, and operating terminals (8-11) and/or programmable modes connected to the control circuits or control means so that the motor (16) can be set at an automated or manual maximum or unlimited permitted forward feed on one actuation.

The invention relates to a dispenser for the power-operated forward feed of a sheet material in the form of paper or the like, especially for the purpose of wrapping, where a material roll is arranged in a stand placed on a casing housing power supply and an electric motor, actuation of the motor causing the forward feed of the material before it is cut off by means of a cutting device, means being provided for selecting the desired length to be cut off, which means include a mechanism that is controlled electronically, and a control terminal and a coin machine, as disclosed in the preamble of independent claim 1.

Wrapping paper is usually supplied on rolls that are arranged in a stand. On use, the desired length of paper is pulled forward and then cut off by using of a suitable knife or tearing arrangement. The paper rolls are as a rule arranged above one another in such a way that papers of different types and breadths are available. Traditionally, such paper roll stands were placed on the shop counter or other suitable place for use by the shop assistants. However, as an efficiency measure, many shops have done away with the wrapping services provided by staff and instead offer the customer access to free wrapping paper on the principle of self service. This has often led to an overuse of paper, which means increased expenses and in its most extreme consequence may also have an adverse impact on the environment.

In, e.g., florist shops there is a need for several types of wrapping paper. For the staff it is therefore of major importance for their working environment that these wrapping papers are readily available and easy to procure in the right length or size.

There is thus a need for a dispenser for simple and rapid supply of wrapping paper in the right length and quantity. There is also a need for the paper to be supplied without the possibility of unauthorised appropriation of extra paper.

WO 97/03422 discloses an automatic paper dispensing machine of the type mentioned in the introduction. The document describes an apparatus for the automatic forward feed and supply of a desired length of wrapping paper. The length can be selected from an operating device that can be controlled by the insertion of a coin. Equipment that controls an electric motor and a cutting device is described. The apparatus is intended to supply the paper ready rolled-up and the patent application is specifically directed towards the devices for performing the rolling up.

DE Patent 3,615,033 describes an apparatus for the automatic dispensing of curtain lengths. The dispensing and cutting of pre-selected lengths of the material is controlled by digital control means. The patent is especially directed towards solving problems relating to correct measurement of curtain lengths, and control means for this purpose are described. These are not considered particularly relevant to paper dispensing machines of the same type as the dispenser according to the present invention.

Furthermore, U.S. Pat. No. 3,276,706 discloses a power-operated dispenser for dispensing paper from rolls. The rolls are arranged above one another in a support structure and an electric motor drives drive belts for selectively feeding the paper. The document teaches three rolls above one another and selection of paper is made by using push bars that bring the relevant drive belt into engagement with the selected paper for the forward feed thereof. The push bar is held in until the relevant length of paper has been dispensed. The US device is primarily intended for home use and even though it probably works extremely well, it is not suitable for solving the problems that are the basis of the present invention.

Thus, the invention relates to a dispenser of the aforementioned type that meets a long-felt need, which the prior art in the field has not been able to meet in an optimal manner. This is achieved in that the dispenser is designed to have the characterising features as disclosed in the characterising clause of patent claim 1.

Advantageous embodiments of the invention are set forth in the dependent patent claims.

The invention will now be described with reference to the drawings, wherein:

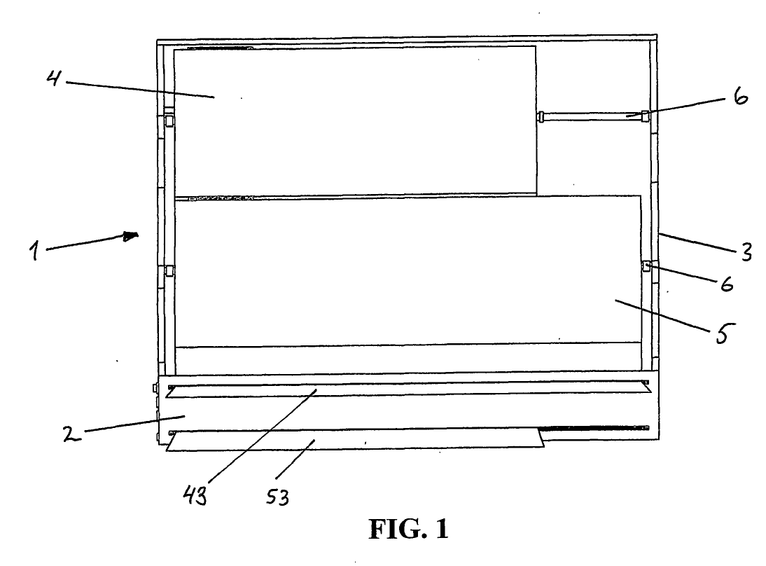

FIG. 1 is a front view of a dispenser according to the invention;

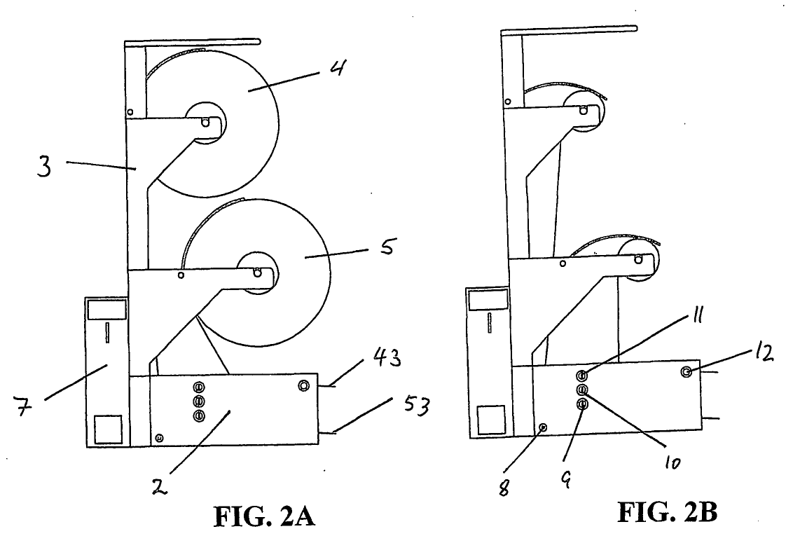

FIGS. 2A-B are side views of the dispenser;

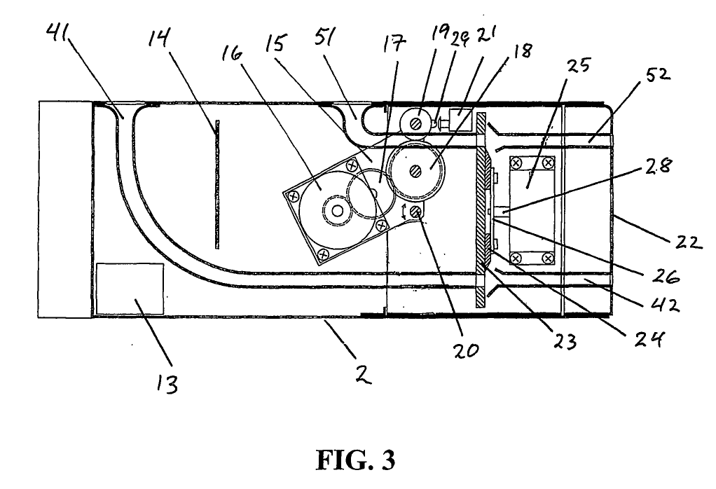

FIG. 3 is a schematic cutaway side view of part of the dispenser, in partial section;

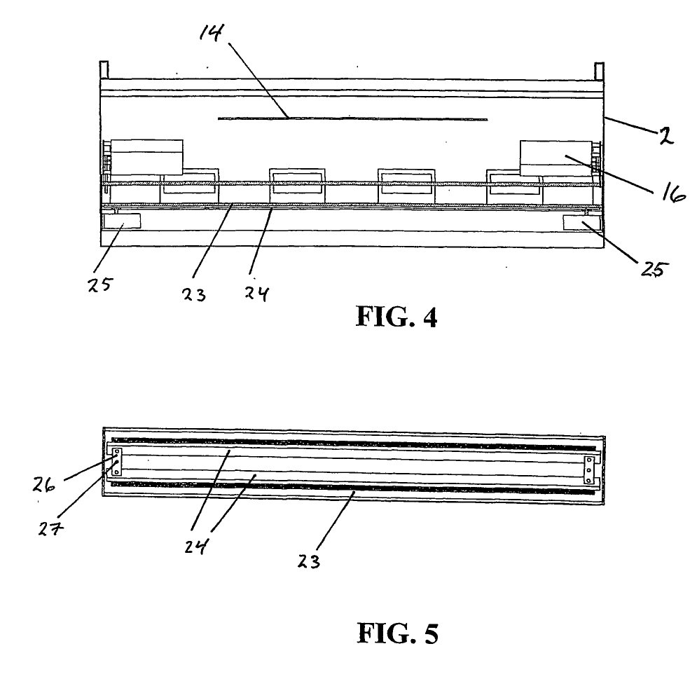

FIG. 4 is view corresponding to FIG. 3, seen from above; and

FIG. 5 shows a plate having openings for paper and an arrangement of cutting blades.

The apparatus according to the invention, which may be called a paper dispenser or automatic paper machine, is generally indicated by means of the reference numeral 1. It is primarily intended for mounting on a horizontal table or counter and comprises a casing portion 2 and a preferably adjustable stand portion 3. The machine 1 can in a suitable manner be rendered pilfer-proof. Rolls of the sheet material that is to be delivered and cut are arranged in the stand portion 3. The illustrated embodiment shows two rolls of paper 4 and 5 of different width arranged on supports 6 that are in turn mounted in the stand 3. In addition to having different widths, the rolls 4 and 5 can of course be completely different types of paper, for example, grey wrapping paper, gift wrapping paper, cellophane etc. A coin machine 7 may be provided in connection with the casing 2. Various operating terminals such as key switches/multimode terminal may be mounted in the casing wall, as indicated schematically in FIGS. 2A and 2B. These may, for example, be a socket outlet 8 for the remote control of the cutting operation, e.g., by using a foot pedal, a key switch 9 for detaching/attaching the coin machine 7, a key switch 10 for overriding the coin machine 7, a key switch 11 for the manual feed of paper and a push button 12 for the cutting of paper.

Inside the casing 2 is arranged a power supply 13, a printed circuit board 14, and in the illustrated embodiment two step motors 16 or the like for paper feed. The motors 16 are mounted on respective frames 15. The motor frame 15 is pivotally mounted on a shaft 20. The motor 16 is equipped with a driving roller 17 for driving an auxiliary roller which in turn cooperates with a pressure roller 19 that is also mounted on the frame 15. In a preferred embodiment, the driving roller 17 is a toothed wheel and the auxiliary roller 18 has an cooperating toothed rim or the like mounted thereon. The frame 15 or the support of the roller 19 is equipped with a projection 29 for activation of a switch 21 that is fixed in the housing 2 for supplying power to the motor 16. The switch 21 is preferably of the type that registers and responds to the length of time for which the operating button is depressed. The activation of the switch 21 can also take place in other suitable ways. The essential point is that the tensioning or pulling down of the paper or sheet helps to determine how long the switch button or similar is depressed.

In FIG. 3 for the sake of clarity only one motor arrangement is shown, namely for the upper paper feed, but a similar arrangement is also provided for the lower feed. The motor arrangement can also be mounted differently, or optionally fixed without mounting on the shaft 20, but in that case it must have another sensor system.

Two guides 41 and 51 are arranged in the casing 2 for the forward feed or dispensing of paper from the rolls 4 and 5. There is also provided a plate wall 23 with two rectangular, horizontal slots that interact with cutting blades or knives 24. The wall 23 may optionally be slightly conical in shape, so that the knives 24 are self-sharpening. In the illustrated embodiment, two electromagnets 25 of the type that have a two-way electromagnetic arm 28 are provided. The cutting blades or knives 24 are connected by means of an articulated member 26 in which hole 27 is provided for a pin-shaped end of the arm 28, see FIGS. 3 and 5.

Lastly, located inside the casing 2 is an end piece 22 equipped with paper guides 42 and 52 respectively and associated slots for dispensing paper. The mechanisms for paper feed and cutting are, for example, mounted together in a unit arranged in the casing 2 before the end piece 22 is put in place.

The power supply 13 includes a transformer for mains voltage 115/230V, and rectifiers and associated smoothing circuits etc. so that a suitable direct-current voltage, e.g., 24V, can be supplied to the electronic components and the other equipment that is to be operated. The printed circuit board 14 is so configured that it comprises the necessary electronic circuits for providing the desired control functions, i.e., motor control for delivering measured, purchased or in some other way determined length of paper, control of the motor drive and control of the electromagnets 25 for cutting the paper etc.

Before the machine is put into service, the paper roll or rolls must be installed and the paper arranged in the guides 41 and/or 51, and moved forward by the motor 16 so that the paper is in place between the auxiliary roller 18 and the pressure roller 19 and the paper extends a suitable length beyond this area. When the machine is then actuated, either by using the coin machine, or by overriding it, the paper end or ends 43 and/or 53 will automatically be guided forwards so that it or they project some centimetres from the slot or slots in the end piece 22. When there is a pulling effect on the paper because someone pulls on the end of the paper, the whole frame 15 will turn on its shaft 20 and the projection 29 will come into contact with the switch 21 which in turn actuates power supply to the motor 16 and subsequent rotation of the driving roller 17. The roller 17 in turn drives the auxiliary roller 18 which together with the pressure roller 19 provides forward feed of the paper and the delivery thereof through the slot in the end piece 22. To obtain a continuous paper flow, there must always be a certain pulling effect on the paper. If the pulling effect is increased, this will be registered in the switch 21 or by a suitable sensor device that reacts to the turning of the frame 15, and the power supply to the motor will be controlled so that the motor 16 increases speed and the paper feed rate increases. When the pulling force ceases, the switch 21 will be turned off, the motor 16 will die and the paper flow will come to a stop. When the dispenser/machine is used without a coin machine, all the sheet materials will at any given time be in position, ready for forward feed, and after cutting they will come forward into position again.

The paper the user pulls on will be the paper he buys or selects. The other paper is immediately retracted into the apparatus 1. If the user chooses to cut the paper before the purchased length has been reached, both papers will come forward, thus allowing the user to select once more which paper he wants. Alternatively, the machine can be so configured that when a coin is inserted, only one length of paper can be bought, but the user can, of course, select paper as disclosed above.

The actuation of the cutting mechanism can take place in many ways. For example, it can be triggered automatically when the purchased/measured paper length has been dispensed or when the pull on the paper ceases. It can be actuated by means of the key switch 11 or the push button 12 etc. Means are provided to ensure that the cutting mechanism always knows which paper is to be cut.

The actual cutting mechanism works so that when, for example, the uppermost paper is to be cut, the electromagnets 25 are activated, one before the other, and by means of the arms 28 coupled to the articulated members 26, the upper cutting blade 24 is caused to move upwards. Since the activation of the two electromagnets 25 is time-staggered, the result will be a cutting movement of the cutting blade 24 as if cutting the paper with a pair of scissors. When the lowermost paper is cut, a similar sequence takes place, but now with the lowermost knife 24 as the active cutting element in a downward movement. Other cutting arrangements are also possible, e.g., laser, wires etc.

The apparatus according to the invention can be provided with or without the coin machine 7. The first variant is intended for customers who buy wrapping paper by inserting a coin. The second variant is primarily intended for the shop staff who wrap items. Both variants are manufactured in the same way and the only difference is the connection of the coin machine 7. This is constructed in a conventional manner with slots for the insertion of coins and a return pocket for invalid/rejected coins. It is also preferably equipped with a display that shows the length or number of sheets of paper due. It should be possible to configure it for different currencies, and similarly it should be possible to choose the length unit, e.g., metres or feet. There must be a corresponding relation between the paper lengths present at any given time on the rolls 4, 5 and the length of paper that can be sold at the same time. Data concerning the length of paper on a new roll installed in the machine can be entered in a suitable manner in a control device, preferably the printed circuit board 14, which is connected to the measuring device or a counter and which is set at zero when the paper roll is changed.

1-10. (canceled)

11. A dispenser for power-operated forward feeding of a sheet material suitable for wrapping purposes, such dispenser comprising:
a stand supporting a roll of the sheet material;
a casing associated with said stand and housing a power supply and an electric motor, said motor operable to forward feed the sheet material;
a cutting device operable to cut the sheet material fed by said motor;
a selecting means for selecting a length of the sheet material to be cut by said cutting device, said selecting means including at least one of an operating terminal and a coin machine;
a frame pivotally supported on a shaft, said motor arranged on said frame and capable of driving associated rollers; and
a projection disposed either on said frame or in connection with support of a pressure roller mounted on said frame;
wherein tension in the sheet material downstream of a point at which forward-feed power of the motor is applied to the sheet material enables a turning of said frame and said projection;
wherein said projection operates a switch arranged in said casing, said switch enabled to connect said power supply to said motor.

12. A dispenser according to claim 11, wherein said switch registers and responds to a length of time said switch is activated by said projection, whereby said power supply to said motor can be controlled.

13. A dispenser according to claim 11, further comprising an electromagnetic means having an arm connected to said cutting means by an articulated member, wherein said cutting device includes a plate wall having at least one slot interacting with said cutting means, said cutting means being moveable across said slot in said plate wall by said electromagnetic means.

14. A dispenser according to claim 13, wherein said cutting means is selected from a group comprising: a cutting blade, a cutting knife, a laser, a wire and chain-driven cutting plates.

15. A dispenser according to claim 13, wherein said at least one slot in said plate wall includes a plurality of slots, said cutting means includes a cutting means for each of said plurality of slots, said articulated member includes a plurality of articulated members, and said electromagnetic means includes a plurality of electromagnetic means, each of said cutting means being connected via one of said plurality of articulated members to a respective one of said plurality of electromagnetic means, said plurality of electromagnetic means operable to provide two-way movement, wherein said arm of said respective electromagnetic means is operable to perform a cutting movement of the cutting means.

16. A dispenser according to claim 15, wherein said two-way movement of said plurality of electromagnetic means includes staggering time and direction of movement.

17. A dispenser according to claim 11, wherein said selecting means is programmable to set at a forward-feed mode selected from a group comprising: automated maximum forward feed, manual maximum forward feed, and unlimited permitted forward feed.

18. A dispenser according to claim 17, wherein said selecting means is selected from a group comprising: a socket outlet for remote control of cutting; a first key switch for deconnecting/connecting said coin machine; a second key switch for overriding said coin machine; a third key switch; a push button for cutting the sheet material; and one key for making ready all said forward-feed modes and a mode for programming.

19. A dispenser according to claim 17, wherein said selecting means is programmable to set feeding of the sheet material to be carried out without motor assistance, said motor only forward feeding newly fed sheet material after a cutting operation by said cutting device, whereby said dispenser is ready for non-motorized withdrawal of the sheet material.

20. A dispenser according to claim 11, wherein said motor includes a step motor.

21. A dispenser according to claim 11, wherein said selecting means is programmable to set feeding of the sheet material to be carried out without motor assistance, said motor only forward feeding newly fed sheet material after a cutting operation by said cutting device, whereby said dispenser is ready for non-motorized withdrawal of the sheet material.
